(19) United States
(12) Patent Application Publication
(10) Pub. No.: US 2010/0011587 A1
(43) Pub. Date: Jan. 21, 2010

(54) ELECTRICAL HAIR-CUTTING DEVICE

(75) Inventors: Wolfgang Obermann, Klagenfurt (AT); Christoph Markus Zagorski, Klagenfurt (AT); Arthur Putzer, Bad Eisenkappel (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/443,866

(22) PCT Filed: Oct. 4, 2007
(86) PCT No.: PCT/IB07/54030

§ 371 Date: Apr. 1, 2009

(30) Foreign Application Priority Data
Oct. 6, 2006 (EP) 06121912.7

(51) Int. Cl. B26B 19/42; B26B 19/00

(52) U.S. Cl. 30/34.2; 30/43.2

(57) ABSTRACT

The invention is related to an electrical hair-cutting device (500) comprising: an external hair-cutting element (502) with hair entry openings and an internal hair-cutting element that is movable relative to the external hair-cutting element (502) a preferred direction of movement (546) over skin;—a hair guiding or hair manipulating member that is arranged in front of the external hair-cutting element (502), seen in the preferred direction of movement (546) over the skin; and an adjustable skin support member (524) that is arranged behind the external hair-cutting element (502), seen in the preferred direction of movement (546) over the skin.

### FIELD OF THE INVENTION

The invention is related to an electrical hair-cutting device comprising an external hair-cutting element with hair entry openings and an internal hair-cutting element that is movable relative to the external hair-cutting element, a preferred direction of movement over skin, and a hair guiding or hair manipulating member that is arranged in front of the external hair-cutting element, seen in the preferred direction of movement over the skin.

### BACKGROUND OF THE INVENTION

It is known in connection with hair-cutting devices to arrange an elongated skin support member in front of a first hair-cutting area with respect to a first preferred direction of movement to align the first hair-cutting area with respect to the skin to be treated. However, there is a problem in that hair to be cut is pressed down by the skin support member, which makes the hair difficult to catch. A further problem is that harder and softer skin types at least in some cases need a different alignment of the hair-cutting area and the skin. This is due to the fact that moving a hair-cutting device over skin to be treated leads to the what is called skin doming effect, which is the effect that the skin will locally be deformed and penetrate into the hair entry openings of the external hair-cutting element. The skin doming effect will lead to skin irritations or even skin injuries and should therefor be limited. The degree of the skin doming effect depends on the hardness of the skin. Harder skin can, for example, be the skin of a human leg, while softer skin can, for example, be the skin of a human armpit. For softer skin the degree of the doming effect is greater than for harder skin. Therefore, the known hair-cutting devices are optimized for one skin type (hard/soft) only. However, if the alignment of the hair-cutting area and the skin to be treated is not optimal, the skin may be irritated or even injured.

### BRIEF SUMMARY OF THE INVENTION

It is an object of the invention to provide an electrical hair-cutting device of the kind mentioned in the opening paragraph which provides excellent shaving results for all skin types (hard/soft) without the risk of skin irritations or even skin injuries.

According to the present invention, the above object is solved by providing a hair-cutting device according to claim 1. Preferred embodiments and further developments are outlined in the dependent claims.

The invention provides an electrical hair-cutting device comprising: an external hair-cutting element with hair entry openings and an internal hair-cutting element that is movable relative to the external hair-cutting element; a preferred direction of movement over skin; a hair guiding or hair manipulating member that is arranged in front of the external hair-cutting element, seen in the preferred direction of movement over the skin; and an adjustable skin support member that is arranged behind the external hair-cutting element, seen in the preferred direction of movement over the skin. Thereby, best smoothness can be obtained for different skin types (hard/soft) without the risk of skin irritations or injuries. This is due to the fact that it has been found that with an adjustable skin support member arranged behind the external hair-cutting element the degree of the skin doming effect can be influenced. Therefore, an optimal alignment of the external hair-cutting element and the skin to be treated can be realized without pressing down hair to be cut. Since the skin support member is adjustable, an optimal alignment can be reached also for different skin types (hard/soft). Therefore the term “adjustable” as used herein is intended to encompass all possibilities that lead to a change of the alignment between the external hair-cutting element and the skin to be treated. To achieve this, the skin support member can particularly be moved, changed or detached.

With preferred embodiments of the hair-cutting device in accordance with the invention the adjustable skin support member is spring-loaded and as such freely movable perpendicular to the preferred direction of movement. In such a case it is preferred that the arrangement is such that the elongated adjustable skin support member is pressed against the skin to be treated by the spring force(s). Thereby, an automatic adjustment of the skin support member is obtained. It is preferred that the spring force(s) significantly increases (increase), after the elongated adjustable skin support member has moved a first distance. Thereby, softer skin can be efficiently supported, while the desired doming effect can be utilized for harder skin.

Additionally or alternatively, it is also possible that the adjustable skin support member is adjustable to at least one fixed position and as such movable perpendicular to the preferred direction of movement. For example, it is possible for the hair-cutting device in accordance of the invention, that there is provided a knurled screw for adjusting the elongated adjustable support member. The term “knurled screw” as used herein is intended to encompass all solutions where a user can turn a nut, a screw and the like to influence the depth of the space between the two elongated hair-cutting areas. Preferably, at least one marker is provided for marking at least one adjustment of the knurled screw. The knurled screw can be used to directly move the elongated adjustable skin support member, to spring load a spring, to define a stop position and so on. Of course it is also possible to provide similar solutions by using adjustment elements that can be pushed in a desired position.

Furthermore, it is possible that the adjustable skin support member is removable at least in part. For example the elongated adjustable skin support member can be detached for treating harder skin and can be mounted for treating softer skin. Of course it is also possible to provide a plurality of adjustable skin support members having a different thickness to alter the depth of the space between the two hair-cutting areas. Particularly if the adjustable skin support member is detachable and thereby replaceable, it is possible that the adjustable skin support member secretes a substance, for example for treating and/or easing the skin.

In a preferred embodiment of an electrical hair-cutting device according to the invention, the adjustable skin support member has at least two skin support surfaces which have mutually different shapes, and each skin support surface is positionable in an operational position relative to the external hair-cutting element by moving the adjustable skin support member relative to the external hair-cutting element. In this preferred embodiment, the skin support surfaces each have an individual shape which is adapted to the degree of the skin doming effect characteristic for a certain part of the body to be treated. In this way, a number of different body parts having different degrees of the skin doming effect and different sensitivities can be treated using only a single adjustable skin support member.

In a further embodiment of an electrical hair-cutting device according to the invention, the adjustable skin support member is removable and positionable relative to the external hair-cutting element in a number of operational positions equal to the number of skin support surfaces. In this embodiment, the user can expose a desired skin support surface in an operational position by simply removing the adjustable skin support member from the device, turning it in a correct position, and repositioning it on the device so that the desired skin support surface is exposed to the skin.

In a further embodiment of an electrical hair-cutting device according to the invention, the adjustable skin support member has an elongated shape, wherein two skin support surfaces are provided on opposite sides of the adjustable skin support member. In this embodiment, the user can expose a desired skin support surface in an operational position by simply turning the adjustable skin support member over 180° about a longitudinal axis of the adjustable skin support member.

In a further embodiment of an electrical hair-cutting device according to the invention, the adjustable skin support member has a detectable element by means of which an actual operational position of the adjustable skin support member is detectable. By detecting the operational position of the adjustable skin support member, preferably automatically, an operational parameter of the hair-cutting device, for example a speed of the internal hair-cutting element relative to the external hair-cutting element, can be automatically adjusted dependent on the operational position of the adjustable skin support member.

In a further embodiment of an electrical hair-cutting device according to the invention, the skin support surfaces have mutually different curvatures. In this embodiment, preferably a skin support surface with a relatively strong curvature is present for the treatment of relatively sensitive body parts, and a skin support surface with a relatively weak or even no curvature is present for the treatment of relatively hard body parts.

In accordance with a plurality of embodiments it is preferred that the external hair-cutting element is an elongated external hair-cutting element wherein the adjustable skin support member is an elongated adjustable skin support member arranged at least substantially parallel to the elongated external hair-cutting element. In the easiest case the external hair-cutting element and the adjustable skin support member can be straight parts. However, in cases of a curved external hair-cutting element the adjustable skin support member is preferably adapted to the shape of the hair-cutting area to provide a constant alignment of the hair-cutting area and the skin to be treated.

A highly preferred embodiment of the electrical hair-cutting device in accordance with the invention comprises the following features: the external hair-cutting element is a stationary cutter member having an outer surface, a chamber bounded by an inner surface, wherein the hair entry openings extend from the outer surface to the inner surface; the internal hair-cutting element comprises at least one cutting edge, the internal hair-cutting element fitting in the chamber with a free, close fit; and a drive is coupled to the internal hair-cutting element for driving movement of the internal hair-cutting element relative to the external hair-cutting element. Such hair-cutting means can be referred to as tube cutters. Tube cutters provide excellent shaving results.

In this connection it is preferred that the internal hair-cutting element includes a carrier oriented in longitudinal direction of the internal hair-cutting element, the cutting edges being provided on cutters projecting radially from the carrier. Because the or each movable cutter member includes a carrier extending in longitudinal direction, along at least a number of the cutters of the movable cutter member, and the cutting edges are provided on the cutters projecting radially from the carrier, the cutter member can be manufactured to tight tolerances easily and is radially stiff, so that maintenance of the close, free fit in operation is reliably ensured. The movable cutter member accommodates to non-straightness of the chamber relatively easily, because the longitudinally oriented carrier from which the cutters project towards the inner surface bounding the chamber has a cross-section that is considerably smaller than the cross-section of the chamber.

In this connection it is further preferred that the internal hair-cutting element includes a rod section with recesses, the cutting edges being integrally formed with the carrier by edges of the recesses.

Furthermore, it is preferred that the internal hair-cutting element has a largest cross-sectional size smaller than 10 mm. It is also possible that the cross sectional size of the stationary external hair-cutting element is, for example, less than 5 mm. If more than two hair-cutting means are provided, it is of course also possible to use more than one adjustable skin support member.

It is preferred that the chamber has a circular cross-section. However, also other configurations are possible, for example a rectangular cross-section.

It is also regarded as advantageous that the internal hair-cutting element fits in the chamber with a clearance smaller than 50 μm. For instance, to ensure that the clearance is between 10 and 40 μm, for a chamber and an internal movable hair-cutting element having a nominal diameter of 3 mm, the internal hair-cutting element could for instance be worked to ISO tolerance H8 and the chamber could for example be worked to ISO tolerance f7. To achieve the same tolerance range on the clearance for a chamber and an internal movable hair-cutting element having a nominal diameter of 6 mm, the internal hair-cutting element would for instance have to be worked to ISO tolerances H7 and f6 respectively (if the same classes are used with respect to the offset from the nominal size).

At least for some embodiments it is preferred that the electrical hair-cutting device comprises a further external hair-cutting element with further hair entry openings and a further internal hair-cutting element that is movable relative to the further external hair-cutting element, wherein the external hair-cutting element and the further external hair-cutting element are arranged in parallel, and wherein the adjustable skin support member is arranged between the external hair-cutting element and the further external hair-cutting element. In such a case, a preferred direction of movement over the skin is associated with each external hair-cutting element. Thereby, the adjustable skin support member is arranged behind the external hair-cutting element, seen in the preferred direction of movement associated thereto, and behind the further external hair-cutting element, seen in the preferred direction of movement associated with the further external hair-cutting element.

With some embodiments the stationary external hair-cutting element comprises at least one row of ears radially projecting from the outer surface, transitions from the outer surface to the ears being straight or curved with a center of curvature on the outside of the outer surface. Such ears are particularly effective for stretching the skin, if the hair-cutting means are used for shaving relatively smooth skin portions. It is also possible that there is provided a row of ears radially projecting from the outer surface and extending along the stationary cutter member, the ears of said row being located at least partially within an angular range in circumferential sense that is occupied by the at least one hair-catching opening. With some embodiments the chamber contains at least two of said internal movable hair-cutting elements arranged in succession in longitudinal direction of the chamber. In many cases it is cheaper to make a plurality of shorter internal movable hair-cutting elements than one single long internal hair-cutting element. In this context it is preferred that the carriers of said at least two internal hair-cutting elements are linked for transferring the movement of one of said at least two internal hair-cutting elements to another one of said at least two internal hair-cutting elements. Thereby it is sufficient to directly drive only one or at least not all of the internal hair-cutting elements. With some embodiments the at least one hair-catching opening has a length in longitudinal direction of the cutter members that covers a plurality of the cutters. For example, the at least one hair-catching opening of the external hair-cutting element can cover at least 80% of the length of that external hair-cutting element. It is also possible that the at least one hair-catching opening of the external hair-cutting element has the form of a slit extending in the longitudinal direction of the internal hair-cutting element and having a plurality of bays projecting circumferentially from the slit, the cutting edges of the external hair-cutting element extending along said bays. It is also possible that the hair-cutting means comprise: at least one stationary external hair-cutting element having an outer surface, a chamber bounded by an inner surface, and at least one hair-catching opening extending from the outer surface to the inner surface; at least one internal movable hair-cutting element comprising at least one cutting edge, the internal hair-cutting element fitting in the chamber with a free, close fit; wherein the drive is coupled to the internal hair-cutting element for the driving movement of the internal hair-cutting element relative to the external hair-cutting element; wherein the at least one internal hair-cutting element includes a carrier oriented in longitudinal direction of the internal hair-cutting element, the cutting edges being provided on cutters projecting radially from the carrier. The invention is not limited to hair-cutting means of the tube cutter type, but other arrangements comprising reciprocating cutter elements (for example in connection with one or more shearing foils) and/or rotating cutter elements are also within the scope of the invention. Furthermore, the hair catching openings need not open in a direction perpendicular to a plane defined by a number of stationary cutter members arranged side by side, but may also open in a direction more or less parallel to such a plane for effectively catching long hair. The chamber in the external hair-cutting element need not be straight, but may also be curved if the internal hair-cutting element or the internal hair-cutting elements is or are curved and/or sufficiently flexible. Also, the movement of the internal hair-cutting element in the external hair-cutting element need not be reciprocating in longitudinal direction, but may also be or include a rotary movement, for instance about a center line of the chamber in which the internal movable hair-cutting element is fitted.

Instead of or additionally to the tube cutters discussed above it is also possible that at least one of the hair-cutting areas is formed by hair-cutting means of the foil-type cutter. Such foil-type cutters comprise a foil which interacts with a reciprocating cutter element.

### BRIEF DESCRIPTION OF THE DRAWINGS

These and other aspects of the invention will be apparent from and elucidated with reference to the embodiments described hereinafter and shown in the drawings, wherein:

FIG. 1 shows schematic side and front views of an example of a hair-cutting device according to the invention;

FIG. 2 is an enlarged cross-sectional view along a plane in longitudinal direction of the cutter members of portions of the external and the internal hair-cutting elements;

FIG. 3 is an enlarged cross-sectional view along the line II-II in FIG. 2;

FIG. 4 is an enlarged perspective view of portions of the external and the internal hair-cutting elements of another example of the hair-cutting means;

FIG. 5 is an enlarged perspective view of portions of the external and the internal hair-cutting elements of yet another example of the hair-cutting means;

FIG. 6 is an enlarged plan view of a number of alternative elaborations of external hair-cutting elements;

FIG. 7 is an enlarged side view of a configuration of cutter assemblies;

FIGS. 8 and 9 are plan views of two further examples of configurations of cutter assemblies;

FIGS. 10 and 11 are enlarged perspective views of other examples of a possible configuration of cutter assemblies;

FIG. 12 shows in a cross-sectional view the operation of a cutter similar to that shown in FIG. 11;

FIG. 13 is an enlarged cross-sectional view along a plane in longitudinal direction of the cutter members of portions of stationary and movable cutter members of yet another example of hair-cutting means;

FIGS. 14A to 14C schematically show an embodiment of a shearing head for the hair-cutting device in accordance with the invention, wherein the shearing head comprises a spring-loaded elongated adjustable skin support member;

FIGS. 15A and 15B show an embodiment of the hair-cutting device in accordance with the invention, wherein the hair-cutting device comprises a knurled screw for adjusting the elongated adjustable skin support member;

FIGS. 16A and 16B show a further embodiment of the hair-cutting device in accordance with the invention, wherein the elongated adjustable skin support member is detachable;

FIGS. 17A to 17C schematically show an embodiment of the hair-cutting device in accordance with the invention, wherein the hair-cutting device comprises an adjustable skin support member with two skin support surfaces; and

FIG. 18 schematically shows a detail of the adjustable skin support member of the hair-cutting device of FIGS. 17A to 17C.

### DETAILED DESCRIPTION OF THE INVENTION

In the following description equal or similar reference numerals denote equal or similar parts. Furthermore, for the sake of clarity, in several instances, not all corresponding parts in the drawings are designated by reference numerals.

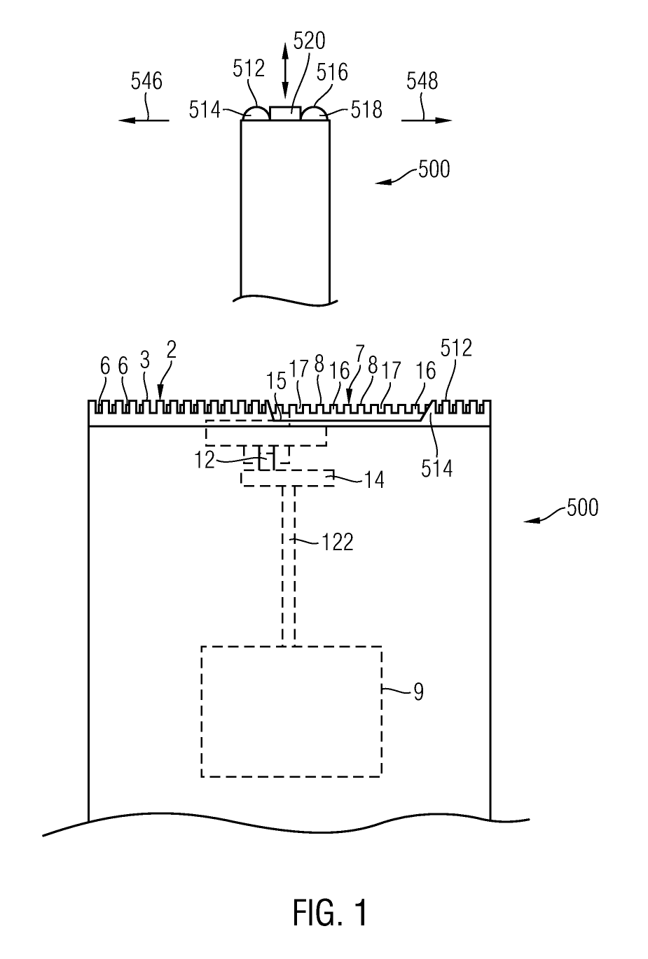

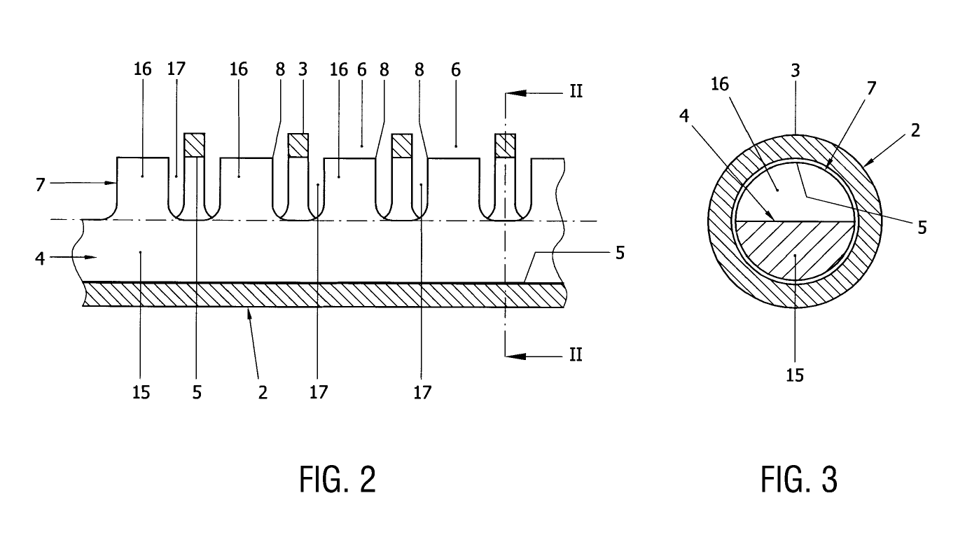

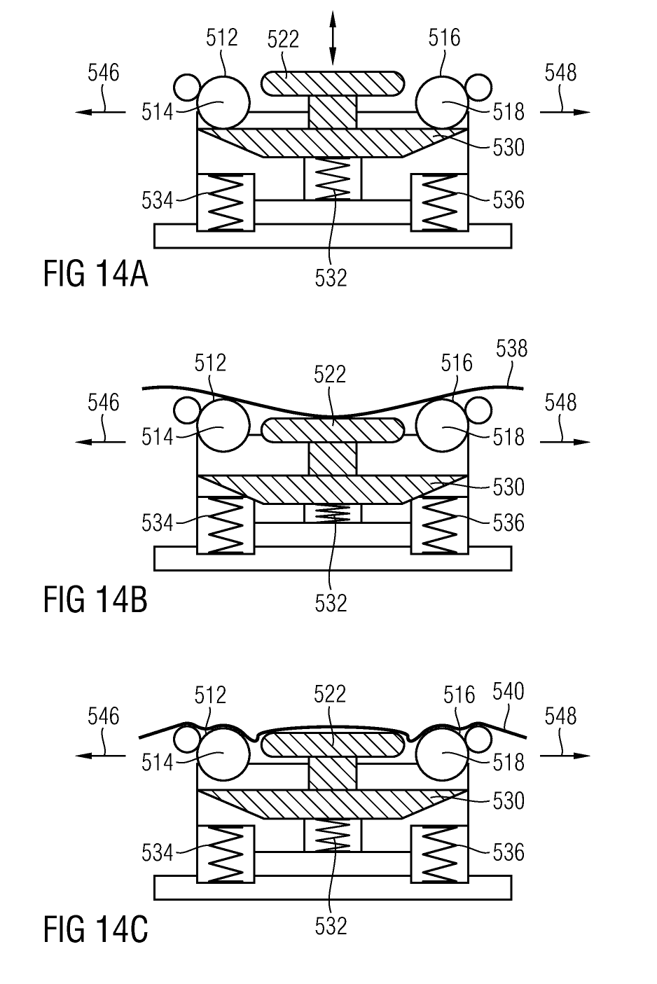

In FIGS. 1-3 an example of a hair-cutting device 500 according to the invention is shown. The upper part of FIG. 1 schematically shows a side view of the upper part of a hair-cutting device 500, and the lower part of FIG. 1 schematically shows the corresponding front view. The hair-cutting device 500 comprises a first elongated external hair-cutting element 2 formed by first hair-cutting means 514 of the tube cutter type and a second elongated external hair-cutting element 52 formed by second hair-cutting means 518 which are also of the tube cutter type. Between the first external hair-cutting element 2 and the second external hair-cutting element 52 there is provided an elongated adjustable skin support member 520 which is adjustable in the direction shown by the arrow. A first preferred direction of movement 546 is associated with the first external hair-cutting element 2 and a second preferred direction of movement 548 is associated with the second external hair-cutting element 52. With respect to the first and second preferred directions of movement 546, 548 the elongated adjustable skin support member 520 is arranged behind both the first external hair-cutting element 2 and the second external hair-cutting element 52. By adjusting the elongated adjustable skin support member 520 the depth of the space between the first external hair-cutting element 2 and the second external hair-cutting element 52 can be varied. Thereby, the maximum possible degree of skin doming is defined as will be described in greater detail with reference to FIGS. 14A to 14C below. The external stationary hair-cutting element 2 has an outer surface 3 for contacting skin to be shaved and a hole or chamber 4 bounded by an inner surface 5 parallel to the outer surface 3. The chamber 4 is profile-shaped. Although in the present example the outer surface is designed for shaving the skin to be shaved smoothly, the outer surface may also be designed and positioned for contacting the skin to be shaved in such a manner that, during the shaving, the hairs are cut off at a predetermined, or at least controlled length, such as when using a hair-clipper. Hair-catching openings 6 extend from the outer surface 3 to the inner surface 5 and are arranged in a row in longitudinal direction of the external stationary cutting element 2. An internal movable hair-cutting element 7 fits in the chamber 4 with a free, close fit and has a row of cutting edges 8, the row being oriented in the same direction as the row of hair-catching openings 6 and as the internal movable hair-cutting element 7. A drive is provided by transmission means 122 in the form of a drive shaft connected to a motor 9 and to an excenter disk 14, wherein a slot 12 in which a knob of the excenter disk 14 is engaged is coupled to the internal movable hair-cutting element 7 for driving movement of the internal movable hair-cutting element 7 relative to the stationary cutter member 2. The free fit of the internal movable hair-cutting element 7 in the chamber 4 helps to avoid radial pressure caused by pre-stress, such as occurs for example when a movable cutter member is resiliently pressed against a stationary cutter member by spring force. Accordingly, additional normal pressure and associated friction added by tightness between the chamber 4 and the movable cutting member are also avoided. The close fit ensures reliable cutting of hairs that are caught between the hair-cutting elements 2, 7. The internal movable hair-cutting element 7 includes a continuous carrier 15 oriented in longitudinal direction of the internal movable hair-cutting element 7. The cutting edges 8 are provided on cutters 16 projecting radially from the carrier 15. The internal movable hair-cutting element 7 can easily be manufactured to tight tolerances and is radially stiff in the sense that dynamic and static loads that are exerted on internal movable hair-cutting element 7 during use cause very little changes in the radial dimensions of the internal movable hair-cutting element 7. For instance, all longitudinal loads, such as loads caused by oscillating movement, friction forces and shear forces exerted on the hairs during cutting, cause very little deformation of the axially extending carrier 15 which is very stiff longitudinally. The cutters 16 each only have to transfer loads that are directly exerted thereon and are not involved in the transfer of loads exerted by or on other ones of the cutters 16 and the loads that are exerted on the cutters 16 during use have only minimal effect on the dimensions of the cutters 16 in radial directions. Thus, maintenance of the close, free fit in operation is reliably ensured. Nevertheless, non-straightness of the chamber 4, which may for instance be caused by manufacturing tolerances or by loads exerted on the external stationary hair-cutting element 2 during shaving, causes only relatively small loads to be exerted on the internal movable hair-cutting element 7 by the chamber 4 and, accordingly, relatively little friction between the internal movable hair-cutting element 7 and the inner surface 5 of the chamber 4, because the longitudinally oriented carrier 15 from which the cutters 16 project towards the inner surface 5 bounding the chamber 4 have a cross-section that is considerably smaller than the cross-section of the chamber 4 and therefore bends relatively easily in planes in its longitudinal direction. According to the present example, the internal movable hair-cutting element 7 includes a rod section with recesses 17 and the carrier 15 is formed by a portion of the rod that is continuous in longitudinal direction of the internal movable hair-cutting element 7. The rod section is preferably solid for large axial stiffness by small bending stiffness, as in this example, but may also be hollow. The cutting edges 8 are integrally formed with the carrier 15 by edges of the recesses 17 in the rod. Thus, the internal movable hair-cutting element 7 can be manufactured in a simple manner and with tight tolerances, for example by cylindrical grinding and grinding the recesses in the rod. Furthermore, the integral construction reduces the risk of damage due to failure of connections between the carrier 15 and the cutters 16. Although in the present example the carrier 15 is continuous in longitudinal direction over the length or almost the length of the external stationary hair-cutting element 2 as well, it is also possible to provide two or more movable cutter members each continuous along the cutters of its own carrier. The plurality of movable cutter members may be separately movable and may also be separately drivable.

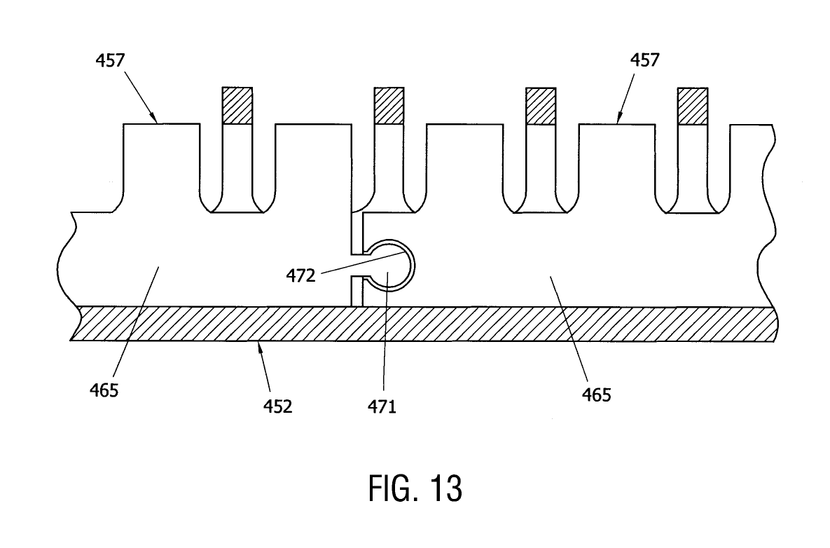

As is shown in FIG. 13, all or some of the plurality of internal movable hair-cutting elements 457 may have its carrier 465 linked to the carrier 465 or carriers of one or more neighbouring internal movable hair-cutting elements 457 to form one or more cutter member chains that are drivable in a simple manner by driving only one or a few of the cutter members, the other cutter members being entrained by the driven cutter members to which they are linked. According to the present example, the carriers 465 are linked by interlocking coupling members 471, 472 that allow a slight pivotal movement of successively linked carriers relative to each other. During assembly, the mutually engaged coupling members 471, 472 slide into engagement. Once arranged in the chamber, mutual movement in lateral direction that would allow the coupling members 471, 472 to disengage is prevented by the internal surfaces of the chamber into which the internal movable hair-cutting elements 457 fit with a close, free fit. Because two or more carriers 465 are arranged in succession in longitudinal direction in the same chamber of an external stationary hair-cutting element 452, the individual carriers 465 may be relatively short, which further facilitates accomodation of the internal movable hair-cutting element 457 to deviations from the nominal shape, such as deviations within a tolerance range, of the chamber.

Referring back to FIGS. 1 to 3, the internal movable hair-cutting element 7 preferably has a largest cross-sectional size smaller than 10 mm and more preferably a largest cross-sectional size smaller than 5 mm or a largest cross-sectional size of 3 mm or less. By providing that the internal movable hair-cutting element 7 and the chamber 4 have small diameters, tight tolerances of the clearance between the internal movable hair-cutting element 7 and the inner surfaces 5 of the chamber can be ensured more easily. For instance to ensure that the clearance is between 10 and 40 μm, for a chamber 4 and an internal movable hair-cutting element 7 having a nominal diameter of 3 mm, the internal movable hair-cutting element 7 could for instance be worked to ISO tolerance H8 and the chamber could for example be worked to ISO tolerance f7. To achieve the same tolerance range on the clearance for a chamber 4 and an internal movable hair-cutting element 7 having a nominal diameter of 6 mm, the internal movable hair-cutting element 7 would for instance have to be worked to ISO tolerances H7 and f6 respectively (if the same classes are used with respect to the offset from the nominal size). This is one tolerance class higher, which requires more precise manufacturing and therefore entails additional cost. Moreover, with the cross-sectional size of the internal movable hair-cutting element 7 and of the chamber 4, the bending stiffness of the internal movable hair-cutting element 7 and of the chamber 4 increases, causing increased friction if internal movable hair-cutting element 7 and/or the chamber 4 are not straight. Another advantage of a small cross-sectional size of the internal movable hair-cutting element 7 and of the chamber 4 is, that the wall portion of the stationary cutter member between successive hair catching openings 6 may be very slender, so that the open hair-catching area may be very large in relation to the total shaving surface and the wall thickness between the shaving surface 3 and the inner surface 5 in the chamber 4 may be very thin, which in turn is advantageous for achieving a close shave. For reliable cutting of hairs of all sorts, the internal movable hair-cutting element 7 preferably fits in the chamber 4 with a clearance smaller than 50 μm and more preferably at most about 30 or 40 μm. For ease of manufacturing, it is furthermore advantageous if the chamber 4 has a circular cross-section, which facilitates working the chamber 4 and the internal movable hair-cutting element 7 to be fitted therein to corresponding sizes and shapes, with tight tolerances. However, instead of the profile of the chamber having a circular cross-section, the profile may also have another shape, such as elliptical, square or triangular, the cutter members being shaped accordingly.

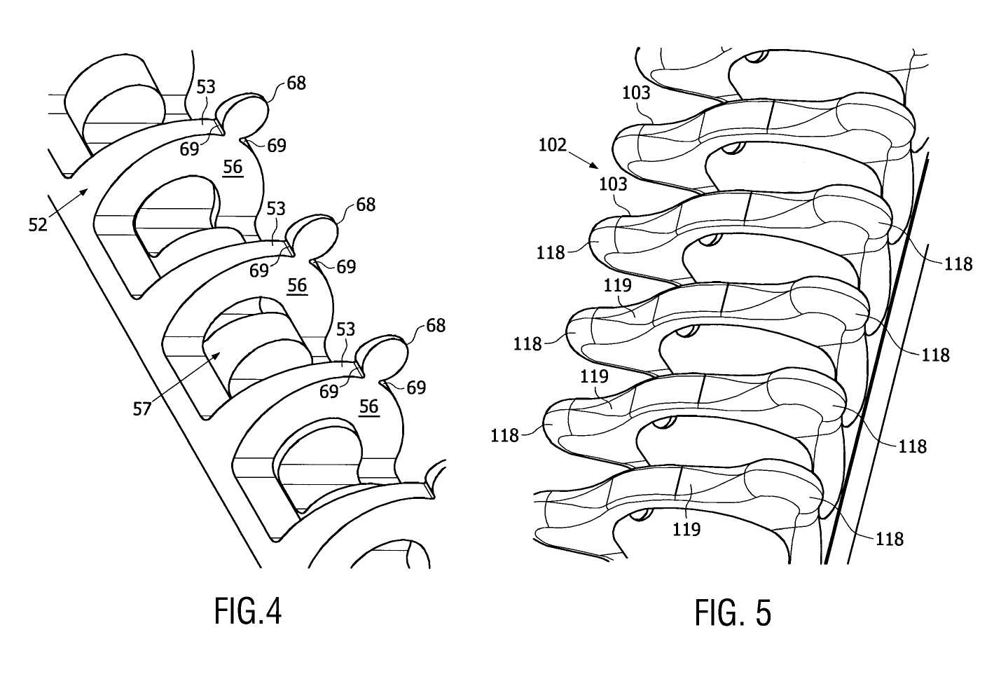

In FIG. 4, portions of an external stationary hair-cutting element 52 and an internal movable hair-cutting element 57 of another example of hair-cutting means are shown. The external stationary hair-cutting element 52 is provided with a row of ears 68 radially projecting from the shaving surface 53 and forming hair guiding or hair manipulating members. Transitions 69 from the shaving surface 53 to the ears 68 are curved with a center of curvature on the outside of the shaving surface 53. Thus, the hair-catching ears 68 are particularly effective for stretching the skin, when the ears 68 are passed over the skin preceding the shaving surface, because the skin is freely tensioned in an area between the ears 68 and the shaving surface 53, where the external stationary hair-cutting element 52 does not contact the skin and therefore exerts no frictional force on the skin in the direction of movement of the ears 68. To at least some extent, this effect may also be achieved if the transitions from the shaving surface to the ears are straight. The straight transitions are preferably flat to obtain evenly distributed contact pressure, but also another shape may be provided. According to the present example, in circumferential sense, the ears 68 are disposed at least partially within the angular range occupied by the hair-catching openings 56 and preferably about 15-19° off-center in circumferential sense with respect to the hair-catching openings 56. This allows to use the ears 68 first as skin stretchers if the hair-cutting device is passed over the skin with the ears 68 leading the portion of the shaving surface 53 that are in contact with the skin and second as spacers for keeping the internal movable hair-cutting element 57 further spaced from the skin if the hair-cutting device is passed over the skin with the ears 68 pointing to the skin approximately perpendicularly to the skin.

In FIG. 5, portions of an external stationary hair-cutting element 102 of yet another example of hair-cutting means is shown. In this external stationary hair-cutting element 102, two rows of ears 118 project radially from the shaving surface 103 on opposite sides of a central portion of the shaving surface 103. Transitions 119 from the shaving surface 103 to the ears 118 are also curved with a center of curvature on the outside of the shaving surface 103. The two rows of ears allow the skin stretching effect to be achieved during passage of the external stationary hair-cutting element 102 over the skin in two opposite general directions.

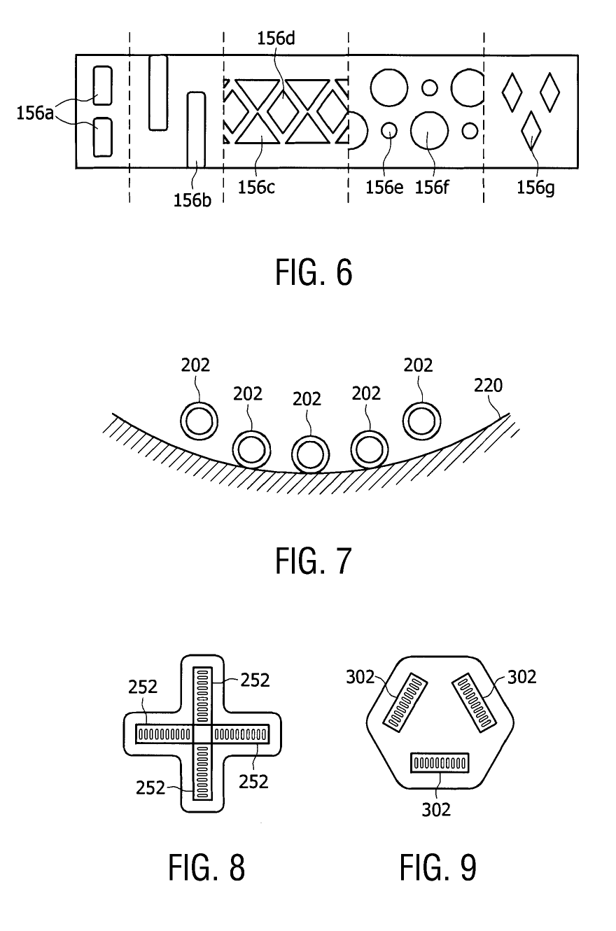

Depending on the envisaged main use of the hair-cutting means, the hair-catching openings 156 can be provided in many forms and patterns as is illustrated by the hair-catching openings 156a-156g in the alternative examples of sections of an external stationary hair-cutting element 152 shown in FIG. 6.

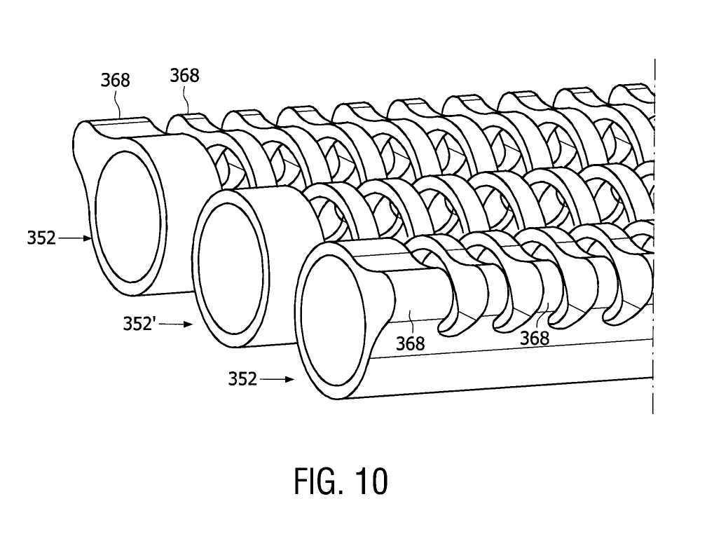

In the example shown in FIG. 7, a plurality of external stationary hair-cutting elements 202 is arranged side by side in an arrangement defining a curved plane. Such an arrangement is advantageous for effectively shaving concave skin areas 220. As in all cases where more than two hair-cutting means are provided, it is preferred that an elongated adjustable skin support member (not shown in FIG. 7) is provided each time between adjacent hair-cutting means. In the example shown in FIG. 8, four external stationary hair-cutting elements 252 are arranged two-by-two in-line along crossing lines. Such an arrangement allows shaving a skin portion quickly by moving over the skin portions in various directions without having to rotate the hair-cutting device accordingly. In such a case, for example, four elongated adjustable skin support members (not shown in FIG. 8) could be provided to form a star configuration. Similar advantages are achieved with another embodiment as shown in FIG. 9 in which the external stationary hair-cutting elements 352 are oriented in different directions, according to this example along lines forming sides of an equilateral triangle. In this case, for example, three elongated adjustable skin support members (not shown in FIG. 9) could be provided adjacent to the external stationary hair-cutting elements 352. In FIG. 10 an arrangement of stationary cutter members 352, 352′ is shown, of which only outer ones are provided with hair-catching and skin-stretching ears 368. In such an arrangement, the number of stationary cutting members is larger than the number of rows of ears, so that apart from the cutting members adapted for catching longer hairs and stretching the skin, also cutting members dedicated for close shaving are provided.

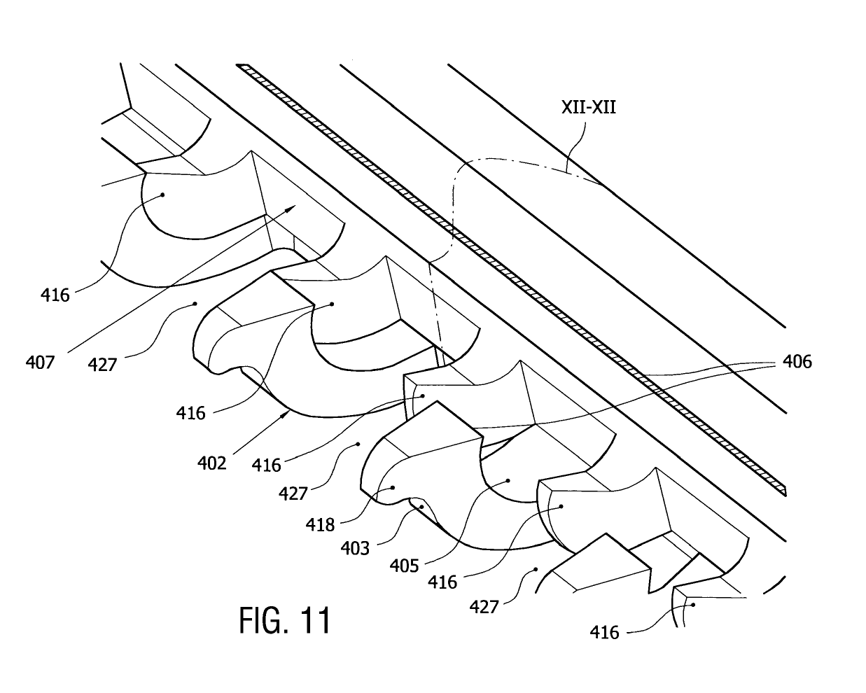

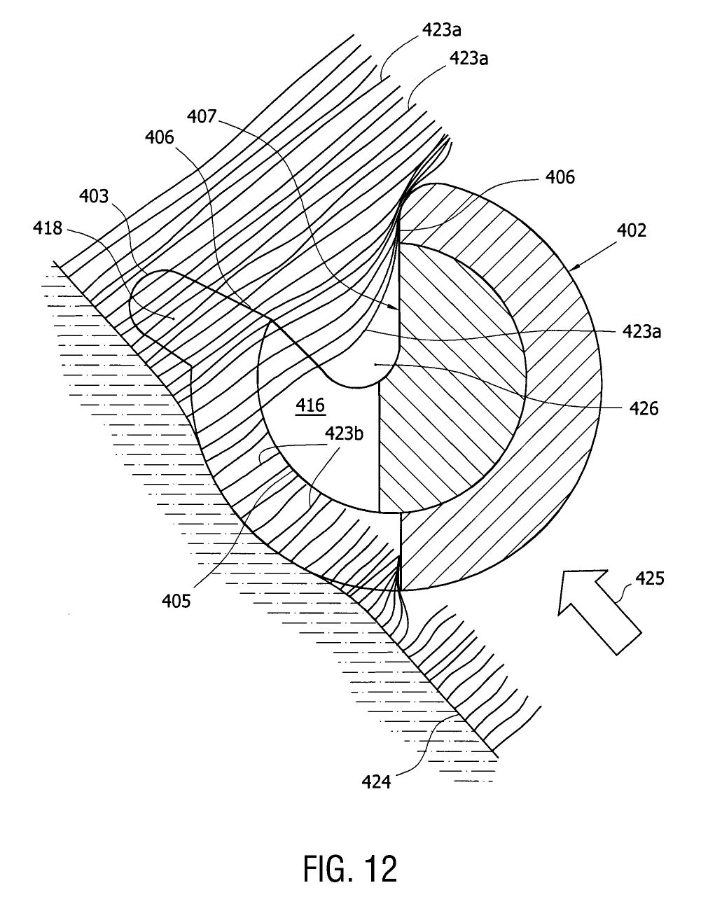

As is illustrated by FIGS. 11 and 12, the hair-cutting means may also have a hair-catching opening 406, which has a length in longitudinal direction of the hair-cutting elements 402, 407 that covers a plurality of the cutters 416. Such hair-catching opening designs are particularly suitable for efficiently trimming long hairs 423a to hairs 423b having shorter remaining length measured from the skin 424 (only some of the hairs are designated by reference numerals), with little risk of the hair-cutting device becoming stuck due to excessive amounts of hair being caught between the cutting members. In use the hair-cutting device is moved in the direction indicated by arrow 425 while in contact with the skin 424 with the ears 403 leading and close to or in contact with the skin 424. As is shown in FIG. 12, in the area where the opening covers a plurality of cutters 416, shearing action for cutting the hairs is absent over a section of the circumference of the internal movable hair-cutting element 407. This allows at least most of the longer hairs 423a to easily reach a segment of the circumference of the internal movable hair-cutting element 407 where the shearing action between the external stationary hair-cutting element 402 and the internal movable hair-cutting element 407 causes the hairs to be cut and allows most of the long hairs 423a to be cut only once, which reduces the resistance encountered by the internal movable hair-cutting element 407 during quick trimming. To further facilitate the entry of long hairs, the circumference of the cutters 416 has recesses 426 forming a continuous, open area with the opening 406. To reduce the length of the sections of the cutter members where entry of long hairs between the cutting edges is impaired, the number of hair-catching openings is preferably small. According to the present example, a single hair-catching opening 406 extends from the outer surface 403 to the inner surface 405. To further reduce the length of the sections of the cutter members where entry of long hairs between the cutting edges is impaired, the hair-catching opening 406 of the external stationary hair-cutting element 402 or of at least one of the internal movable hair-cutting elements 407 preferably covers substantially the chamber length of that external stationary hair-cutting element 402 (preferably at least about 80% and more preferably at least about 90% of the length). A particularly effective design for trimming the hair 423a is obtained if, as in the present example, the hair-catching opening 406 of the external stationary hair-cutting element 402 is in the form of a slit extending in the longitudinal direction of the internal movable hair-cutting element 407 and has a plurality of bays 427 projecting circumferentially from the slit, the cutting edges of the external stationary hair-cutting element 402 extending along said bays 427.

FIGS. 14A to 14C schematically show an embodiment of a shearing head for the hair-cutting device in accordance with the invention, wherein the shearing head comprises a spring-loaded elongated adjustable skin support member 522. The shaving head comprises first tube cutter type hair-cutting means 514 comprising a first external hair-cutting element 502 having a hair guiding or hair manipulating member 568. A first preferred direction of movement 546 is associated with the first external hair-cutting element 502. Furthermore, the shaving head comprises second tube cutter type hair-cutting means 518 comprising a second external hair-cutting element 552 also having a hair guiding or hair manipulating member 568, wherein a second preferred direction of movement 548 is associated with the second external hair-cutting element 552. Between and parallel to the first and second external hair-cutting elements 502, 552 there is arranged a spring-loaded elongated adjustable skin support member 522 which automatically adjusts itself during use in the direction shown by the arrow. With respect to the first and second preferred directions of movement 546, 548 the elongated adjustable skin support member 522 is arranged behind both the first external hair-cutting element 502 and the second external hair-cutting element 552. In FIG. 14A the unloaded elongated adjustable skin support member 522 is in its upper end position, which is forced by a first spring 532 moving the elongated adjustable skin support member 522 upwards until a broader base portion 530 of the elongated adjustable skin support member 522 abuts the undersides of the first and second external hair-cutting elements 502, 552. FIG. 14B illustrates the case where harder skin 538, for example of a human leg, is shaved, and FIG. 14C illustrates the case where softer skin 540, for example of a human armpit, is shaved. The harder skin 538 has a higher stiffness than softer skin 540. Therefore, the harder skin 538 is capable of pressing down the elongated adjustable skin support member 522. If the elongated adjustable skin support member 522 has been pressed down far enough, it additionally interacts with two further springs 534, 536 arranged below the first and second hair-cutting means 514, 518. This is shown in FIG. 14B illustrating the balance of forces and the skin doming effect desired for shaving harder skin 538. Referring to FIG. 14C, the softer skin 540 is only capable of pressing down the elongated adjustable skin support member 522 a little. Thereby, the softer skin 540 is supported and an excessive skin doming effect, which could lead to skin irritation or even injuries, is avoided.

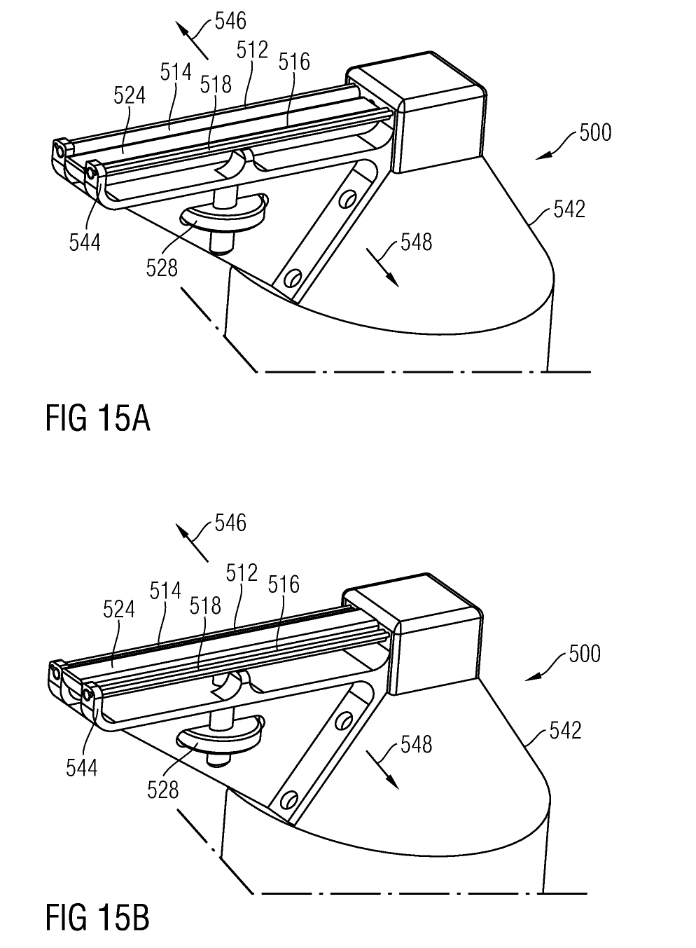

FIGS. 15A and 15B show an embodiment of the hair-cutting device 500 in accordance with the invention. The hair-cutting device 500 comprises a housing 542 having a conical portion which supports a shearing head 544. The shearing head 544 comprises first and second tube cutter type hair-cutting means 514, 518 comprising two elongated external hair-cutting elements 502, 552. The elongated external hair-cutting elements 502, 552 comprise hair guiding or hair manipulating members, for example in the form of ears (not shown). The hair-cutting means 514, 518 are driven on their right end portions by a motor accommodated in the housing 542. Between the first and second hair-cutting means 514, 518 there is provided an elongated adjustable skin support member 524. With respect to the first and second preferred directions of movement 546, 548 the elongated adjustable skin support member 524 is arranged behind both the first external hair-cutting element 502 and the second external hair-cutting element 552. The elongated adjustable skin support member 524 can be moved up and down steplessly with respect to the hair-cutting means 514, 518 by turning a knurled wheel 528. In FIG. 15A the elongated adjustable skin support member 524 is adjusted (moved up) for shaving harder skin, and in FIG. 15B the elongated adjustable skin support member 524 is adjusted (moved down) for shaving softer skin. One or more markers (not shown), can be provided for marking different adjustments. For example it is possible to provide a scale on the knurled screw 528 to enable the user to memorize approved adjustments. It is also possible that one or more markers can be moved and/or attached by the user.

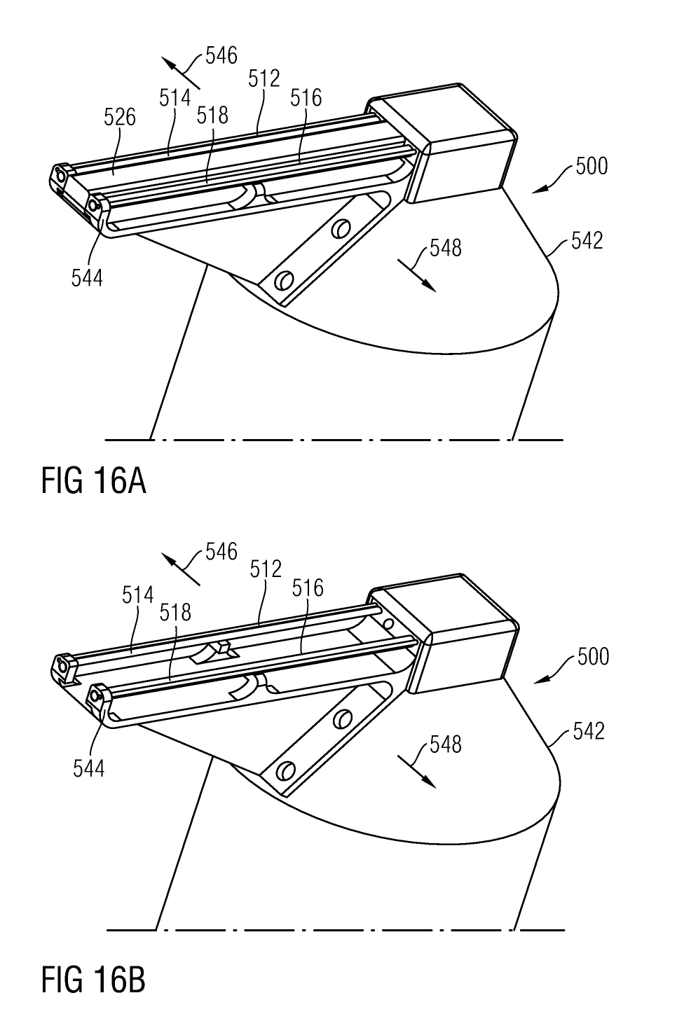

FIGS. 16A and 16B show a further embodiment of the hair-cutting device in accordance with the invention. Except for the differences that will be pointed out in the following, the arrangement is very similar to the embodiment shown in FIGS. 15A and 15B, and therefore reference is made to the corresponding description. With the embodiment shown in FIGS. 16A and 16B no knurled screw is provided, but the elongated adjustable skin support member 536 shown in FIG. 16A and provided for shaving softer skin is completely detachable to configure the device 500 for shaving harder skin. It is also possible to offer different detachable skin support members which comprise different thicknesses to provide more adjustment possibilities. Particularly, but not only, if the elongated adjustable skin support member is detachable and therefore easy to replace, it is possible that the elongated adjustable skin support member secretes a suitable substance, for example for treating and/or easing the skin.

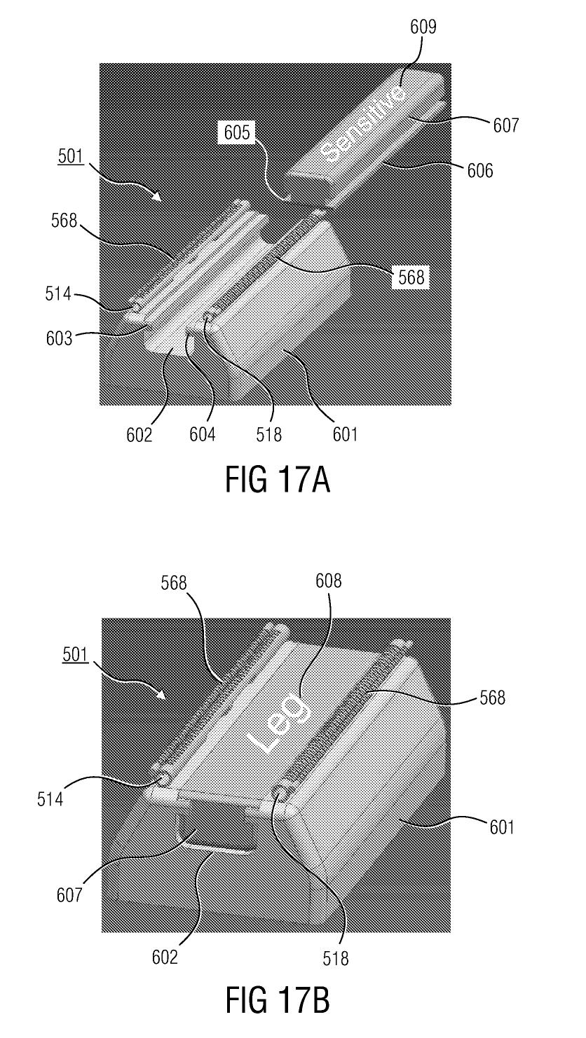

FIGS. 17A to 17C schematically show a further embodiment of a hair-cutting device 501 in accordance with the invention. The hair-cutting device 501 comprises a first elongated tube-cutter type hair-cutting means 514 and a second elongated tube-cutter type hair-cutting means 518 similar to the hair-cutting means 514, 518 of the device 500 shown in FIGS. 15A and 15B. The hair-cutting means 514 and 518 are arranged in parallel on a housing 601 and each have hair guiding or hair manipulating members 568 on a side remote from the respective other hair-cutting means 514, 518. In an area between the hair-cutting means 514, 518 an elongated channel 602 is provided in the housing 601 extending parallel to the hair-cutting means 514, 518. The channel 602 comprises two oppositely arranged guiding flanges 603, 604 which match with two oppositely arranged guiding grooves 605, 606 provided in an adjustable skin support member 607 of the device 501. By sliding the grooves 605, 606 along the flanges 603, 604, the adjustable skin support member 607 can be positioned on the device 501 or removed therefrom.

In the embodiment of FIGS. 17A to 17C, the adjustable skin support member 607 is elongated and has a first skin support surface 608 and a second skin support surface 609 respectively provided on opposite sides of the skin support member 607. Both skin support surfaces 608 and 609 can be positioned in an operational position relative to the hair-cutting means 514, 518, wherein the respective skin support surface 608, 609 is exposed to the skin to be treated. In FIG. 17A, the adjustable skin support member 607 is shown in a position removed from the device 501. In FIG. 17B, the adjustable skin support member 607 is shown in a first operational position on the device 501, wherein the first skin support surface 608 is exposed to the skin. In FIG. 17C, the adjustable skin support member 607 is shown in a second operational position on the device 501, wherein the second skin support surface 609 is exposed to the skin. The user can simply adjust the adjustable skin support member 607 from one of its two operational positions into the other one by removing the adjustable skin support member 607 from the device 501, turning the adjustable skin support member 607 over 180° about its longitudinal axis, and finally repositioning the adjustable skin support member 607 on the device 501.

The first and second skin support surfaces 608, 609 have mutually different shapes, in this embodiment mutually different curvatures. Particularly, the first skin support surface 608 has a relatively weak or even no curvature and the second skin support surface 609 has a relatively strong curvature. As a result, the first skin support surface 608 allows a relatively high degree of penetration of skin into the hair entry openings of the hair-cutting means 514, 518, so that the first skin support surface 608 is particularly suitable for treating relatively hard body parts, such as the legs, which have only a relatively weak skin doming effect. The second skin support surface 609 allows a relatively low degree of penetration of skin into the hair entry openings of the hair-cutting means 514, 518, so that the second skin support surface 609 is particularly suitable for treating relatively soft and sensitive body parts which have a relatively strong skin doming effect. In the embodiment shown, these characteristics of the skin support surfaces 608, 609 are indicated on the skin support surfaces 608, 609 by corresponding wordings or symbols.

It is noted that the skin support surfaces 608, 609 may have different shapes than those shown in the Figures. The surfaces 608, 609 may for example be mainly flat and have one or more local protrusions. A particularly important characteristic of the shape of the skin support surfaces 608, 609 is the degree at which the skin support surfaces 608, 609 protrude relative to an imaginary plane extending through the hair-cutting means 514, 518. A small degree of protrusion generally leads to a small degree of preventing skin to penetrate into the hair entry openings of the hair-cutting means 514, 518, while a high degree of protrusion generally leads to a high degree of preventing skin to penetrate into the hair entry openings of the hair-cutting means 514, 518. A small degree of protrusion is generally suitable for hard skin portions having a relatively small skin doming effect, while a high degree of protrusion is generally suitable for soft and sensitive skin portions having a relatively high skin doming effect. Another important characteristic, which influences the effect of the skin support surfaces 608, 609 on the degree of preventing skin to penetrate into the hair entry openings of the hair-cutting means 514, 518, is the horizontal distance between the hair-cutting means 514, 518 and a local protrusion present on the skin support surfaces 608, 609.

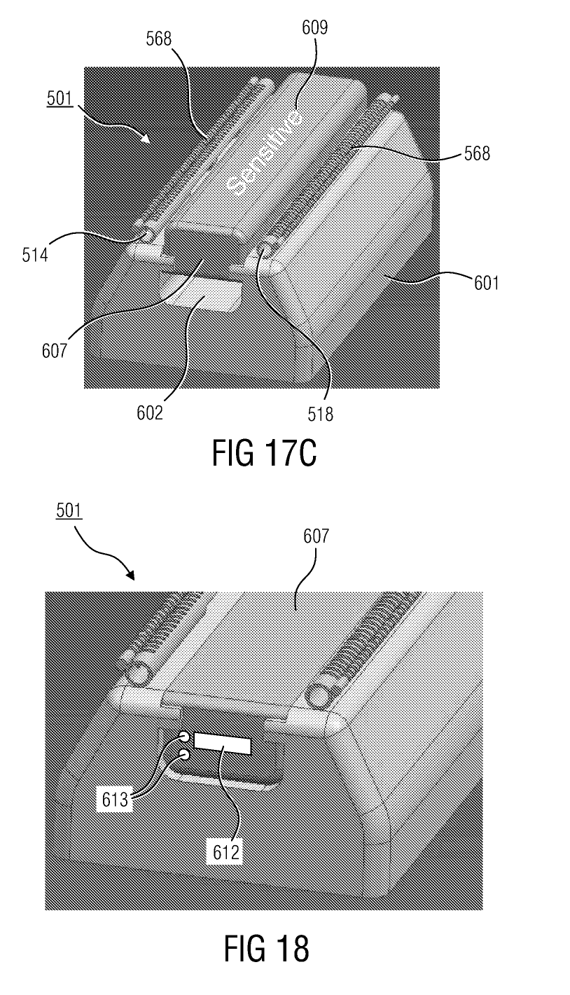

In FIG. 18, an end wall 612 of the adjustable skin support member 607 is shown in detail. In said end wall 612 a detectable element 613 is provided, in the embodiment shown in the form of two electrical contacts. By means of the detectable element 613, an actual operational position of the adjustable skin support member 607 is detectable. For this purpose, the device 501 comprises two separate electrical contacting members, not shown in the Figures, one of said contacting members contacting the detectable element 613 in the first operational position of the adjustable skin support member 607 (shown in FIG. 17B), and the other of said contacting members contacting the detectable element 613 in the second operational position of the adjustable skin support member 607 (shown in FIG. 17C). Said contacting members are electrically connected to a control circuit of the device 501, not shown in the Figures, which is suitable to automatically detect the actual operational position of the adjustable skin support member 607. Dependent on the detected actual operational position of the adjustable skin support member 607, the control circuit automatically adjusts an operational parameter of the device 501, in this example a speed of the hair-cutting means 514, 518.

It is noted that the invention also covers embodiments in which the adjustable skin support member 607 comprises more than two skin support surfaces 608, 609 with mutually different shapes. Instead of being removable from the device 501, the operational position of the adjustable skin support member 607 may be adjustable in a different way, for example by providing a fixed bearing about which the adjustable skin support member 607 can be rotated into the desired operational position.

Finally, it is to be noted that equivalents and modifications not described above may also be employed without departing from the scope of the invention, which is defined in the accompanying claims.

1. An electrical hair-cutting device (500) comprising:
an external hair-cutting element (2; 52; 102; 152; 202; 252; 302; 352; 402; 452; 502) with hair entry openings (6; 56; 406) and an internal hair-cutting element (7; 57; 407; 457) that is movable relative to the external hair-cutting element (2; 52; 102; 152; 202; 252; 302; 352; 402; 452; 502);
a preferred direction of movement (546) over skin;
a hair guiding or hair manipulating member (68; 368; 568) that is arranged in front of the external hair-cutting element (2; 52; 102; 152; 202; 252; 302; 352; 402; 452; 502), seen in the preferred direction of movement (546) over the skin; and
an adjustable skin support member (520; 522; 524; 526) that is arranged behind the external hair-cutting element (2; 52; 102; 152; 202; 252; 302; 352; 402; 452; 502), seen in the preferred direction of movement (546) over the skin.

2. An electrical hair-cutting device (500) according to claim 1, wherein the adjustable skin support member (522) is spring-loaded and as such freely movable perpendicular to the preferred direction of movement (546).

3. An electrical hair-cutting device (500) according to claim 1, wherein the adjustable skin support member (524) is adjustable to at least one fixed position and as such movable perpendicular to the preferred direction of movement (546).

4. An electrical hair-cutting device (500) according to claim 1, wherein the adjustable skin support member (526) is removable at least in part.

5. An electrical hair-cutting device (500) according to claim 1, wherein the adjustable skin support member (xxx) has at least two skin support surfaces (xxx) which have mutually different shapes, and wherein each skin support surface (xxx) is positionable in an operational position relative to the external hair-cutting element by moving the adjustable skin support member (xxx) relative to the external hair-cutting element.

6. An electrical hair-cutting device (500) according to claim 5, wherein the adjustable skin support member (xxx) is removable and positionable relative to the external hair-cutting element in a number of operational positions equal to the number of skin support surfaces.

7. An electrical hair-cutting device (500) according to claim 5, wherein the adjustable skin support member has an elongated shape, wherein two skin support surfaces are provided on opposite sides of the adjustable skin support member.

8. An electrical hair-cutting device (500) according to claim 5, wherein the adjustable skin support member has a detectable element by means of which an actual operational position of the adjustable skin support member is detectable.

9. An electrical hair-cutting device (500) according to claim 5, wherein the skin support surfaces have mutually different curvatures.

10. An electrical hair-cutting device (500) according to claim 1, wherein the external hair-cutting element (2; 52; 102; 152; 202; 252; 302; 352; 402; 452; 502) is an elongated external hair-cutting element (2; 52; 102; 152; 202; 252; 302; 352; 402; 45; 502) and wherein the adjustable skin support member (520; 522; 524; 526) is an elongated adjustable skin support member (520; 522; 524; 526) arranged at least substantially parallel to the elongated external hair-cutting element (2; 52; 102; 152; 202; 252; 302; 352; 402; 452; 502).

11. An electrical hair-cutting device (500) according to claim 1, wherein
the external hair-cutting element (2; 52; 102; 152; 202; 252; 302; 352; 402; 452; 502) is a stationary cutter member (2; 52; 102; 152; 202; 252; 302; 352; 402; 452; 502) having an outer surface (3; 53; 103; 403), a chamber (4) bounded by an inner surface (5; 405), wherein the hair entry openings (6; 56; 406) extend from the outer surface (3; 53; 103; 403) to the inner surface (5; 405);
the internal hair-cutting element (7; 57; 407; 457) comprises at least one cutting edge (8) and the internal hair-cutting element (7; 57; 407; 457) fits in the chamber (4) with a free, close fit; and
a drive (9, 12, 14) is coupled to the internal hair-cutting element (7; 57; 407; 457) for driving movement of the internal hair-cutting element (7; 57; 407; 457) relative to the external hair-cutting element (2; 52; 102; 152; 202; 252; 302; 352; 402; 452; 502).

12. An electrical hair-cutting device (500) according to claim 6, wherein the internal hair-cutting element (7; 57; 407; 457) includes a carrier (15; 465) oriented in longitudinal direction of the internal hair-cutting element (7; 57; 407; 457), the cutting edges (8) being provided on cutters (16) projecting radially from the carrier (15; 465).

13. An electrical hair-cutting device (500) according to claim 7, wherein the internal hair-cutting element (7; 57; 407; 457) includes a rod section with recesses (17), the cutting edges (8) being integrally formed with the carrier (15; 465) by edges of the recesses (17).

14. An electrical hair-cutting device (500) according to claim 6, wherein the internal hair-cutting element (7; 57; 407; 457) has a largest cross-sectional size smaller than 10 mm.

15. An electrical hair-cutting device (500) according to claim 6, wherein the chamber (4) has a circular cross-section.

16. An electrical hair-cutting device (500) according to claim 6, wherein the internal hair-cutting element (7; 57; 407; 457) fits in the chamber (4) with a clearance smaller than 50 μm.

17. An electrical hair-cutting device (500) according to claim 6, comprising a further external hair-cutting element (552) with further hair entry openings and a further internal hair-cutting element that is movable relative to the further external hair-cutting element (552), wherein the external hair-cutting element (502) and the further external hair-cutting element (552) are arranged in parallel, and wherein the adjustable skin support member (520; 522; 524; 526) is arranged between the external hair-cutting element (502) and the further external hair-cutting element (552).
